(19) United States
(12) Patent Application Publication
(10) Pub. No.: US 2022/0126653 A1
(43) Pub. Date: Apr. 28, 2022

(54) BAYESIAN INFERENCE TO LOCALIZE LIGHT ON A VEHICLE MOUNTED VIRTUAL VISOR SYSTEM

(71) Applicant: Robert Bosch GmbH, Stuttgart (DE)

(72) Inventors: Jason Zink, Milford, MI (US); Ryan Todd, Plymouth, MI (US); Xinyu Huang, Cupertino, CA (US); Benzun Pious Wisely Babu, San Jose, CA (US)

(21) Appl. No.: 17/082,778

(22) Filed: Oct. 28, 2020

(51) Int. Cl. B60J 3/02; G06K 9/00; G06N 7/00; G06T 7/70; G06F 3/01

(52) U.S. Cl. CPC B60J 3/0208; B60J 3/0278; G06K 9/00845; G06K 9/00234; G06T 2207/30268; G06T 7/70; G06F 3/013; G06F 3/012; G06N 7/005

(57) ABSTRACT

A virtual visor system is disclosed that includes a visor having a plurality of independently operable pixels that are selectively operated with a variable opacity/transparency. A camera captures images of the face of a driver or other passenger and, based on the captured images, a controller operates the visor to automatically and selectively darken a limited portion thereof to block the sun or other illumination source from striking the eyes of the driver, while leaving the remainder of the visor transparent. The virtual visor system advantageously eliminates unnecessary obstructions to the driver's view while also blocking distracting light sources, thereby improving the safety of the vehicle.

### FIELD

The device and method disclosed in this document relates to anti-glare systems and, more particularly, to vehicle mounted virtual visor system using Bayesian inference to localize light.

### BACKGROUND

Unless otherwise indicated herein, the materials described in this section are not admitted to be the prior art by inclusion in this section.

When driving an automotive vehicle while the sun is low on the horizon, such as in the mornings and evenings, a common problem is that the sun shines through the windshield and disrupts the view of the driver, making it challenging to clearly see the road, traffic signals, road signs, and other vehicles. A conventional solution to this problem is to include manually deployable sun visors mounted adjacent to the windshield of the vehicle. A sun visor is typically an opaque object which can be deployed between a user and the sun to block direct sunlight from striking the driver's eyes. Particularly, the sun visor can be flipped, rotated, or otherwise repositioned to cover a portion of the windshield in an effort to block the sun.

However, in the deployed position, the sun visor generally fails to consistently and continuously prevent the sun from disrupting the view of the driver unless it is frequently adjusted. Particularly, due to its large size and distance from the earth, the sun acts as a directional light source. Thus, in order to block the sunlight, the sun visor must be positioned such that it intersects the subset of the sun's rays that would pass through the position of the driver's eyes. The correct positioning of the sun visor varies as a function of the position of the driver's eyes and the direction of the sunlight relative to the driver's eyes. During a typical driving trip in a vehicle, the vehicle generally changes directions frequently and the driver will move his or her head within the vehicle frequently. Accordingly, a sun visor must be repositioned or adjusted frequently to ensure continuous blockage of the sunlight.

In an effort to overcome these shortcomings, sun visors are typically much larger than is otherwise necessary to effectively block sunlight, such that a single position of the sun visor can block sunlight with a variety of head positions and sunlight directions, thereby reducing the required frequency of adjusting the sun visor. However, this larger size in turn obstructs the view of the driver, often blocking the view of high mounted road signs and stop lights. In order to overcome these issues, the driver often must reposition his or her head so that the visor blocks the sun, while not overly disrupting the rest of his or her view.

What is needed is a visor system which reliably blocks high intensity light sources, such as the sun, while minimizing the disruption to the rest of the view of the driver through the windshield. It would be further advantageous if the visor system continuously and automatically adapts to changes in head position and sunlight direction without manual adjustment by the driver.

### SUMMARY

A visor system for a vehicle is disclosed. The visor system comprises a camera mounted within the vehicle and configured to capture a plurality of images of a face of a passenger of the vehicle. The visor system further comprises a visor mounted within the vehicle and having a plurality of pixels arranged contiguously, an optical state of the visor being adjustable by selectively operating each respective pixel of the plurality of pixels in one of (i) an opaque optical state in which the respective pixel blocks light from passing through a corresponding area of the visor and (ii) a transparent optical state in which the respective pixel allows light to pass through the corresponding area of the visor. The visor system further comprises a controller operably connected to the camera and to the visor. The controller is configured to receive the plurality of images from the camera. The controller is further configured to, for each respective image in the plurality of images, determine, based on the respective image, a current position of the eyes of the passenger. The controller is further configured to, for each respective image in the plurality of images, determine, based on the respective image, a current light direction at which a light source shines through the visor into the eyes of the passenger. The controller is further configured to, for each respective image in the plurality of images, determine an updated optical state for the visor including at least one pixel in the plurality pixels in the opaque optical state to block the light source from shining through the visor into eyes of the passenger, the at least one pixel being selected based on the current position of the eyes of the passenger and the current light direction. The controller is further configured to, for each respective image in the plurality of images, operate the visor to display the updated optical state.

A method for operating a visor system of a vehicle is disclosed. The visor system includes a visor mounted within the vehicle and having a plurality of pixels arranged contiguously, an optical state of the visor being adjustable by selectively operating each respective pixel of the plurality of pixels in one of (i) an opaque optical state in which the respective pixel blocks light from passing through a corresponding area of the visor and (ii) a transparent optical state in which the respective pixel allows light to pass through the corresponding area of the visor. The method comprises capturing, with a camera mounted within the vehicle, a plurality of images of a face of a passenger of the vehicle. The method further comprises, for each respective image in the plurality of images, determining, with a controller, based on the respective image, a current position of the eyes of the passenger. The method further comprises, for each respective image in the plurality of images, determining, with the controller, based on the respective image, a current light direction at which a light source shines through the visor into the eyes of the passenger. The method further comprises, for each respective image in the plurality of images, determining, with the controller, an updated optical state for the visor including at least one pixel in the plurality pixels in the opaque optical state to block the light source from shining through the visor into eyes of the passenger, the at least one pixel being selected based on the current position of the eyes of the passenger and the current light direction. The method further comprises, for each respective image in the plurality of images, displaying, with the visor, the updated optical state.

A non-transitory computer-readable medium for operating a visor system of a vehicle is disclosed. The visor system includes a camera mounted within the vehicle and configured to capture a plurality of images of a face of a passenger of the vehicle. The visor system further includes a visor mounted within the vehicle and having a plurality of pixels arranged contiguously, an optical state of the visor being adjustable by selectively operating each respective pixel of the plurality of pixels in one of (i) an opaque optical state in which the respective pixel blocks light from passing through a corresponding area of the visor and (ii) a transparent optical state in which the respective pixel allows light to pass through the corresponding area of the visor. The computer-readable medium stores program instructions that, when executed by a processor, cause the processor to, for each respective image in the plurality of images, determine, based on the respective image, a current position of the eyes of the passenger. The computer-readable medium further stores program instructions that, when executed by a processor, cause the processor to, for each respective image in the plurality of images, determine, based on the respective image, a current light direction at which a light source shines through the visor into the eyes of the passenger. The computer-readable medium further stores program instructions that, when executed by a processor, cause the processor to, for each respective image in the plurality of images, determine an updated optical state for the visor including at least one pixel in the plurality pixels in the opaque optical state to block the light source from shining through the visor into eyes of the passenger, the at least one pixel being selected based on the current position of the eyes of the passenger and the current light direction. The computer-readable medium further stores program instructions that, when executed by a processor, cause the processor to, for each respective image in the plurality of images, operate the visor to display the updated optical state.

### BRIEF DESCRIPTION OF THE DRAWINGS

The foregoing aspects and other features of visor system and method are explained in the following description, taken in connection with the accompanying drawings.

FIG. 1 is a side view of a portion of a driver compartment of a vehicle showing an exemplary embodiment of a vehicle mounted virtual visor system.

FIG. 2 shows an exemplary embodiment of the visor of FIG. 1.

FIG. 3 shows a method for controlling an optical state of the visor of FIG. 1 to continuously block sunlight from striking the eyes of the driver or other passenger.

FIG. 4 shows a portion of an exemplary image of the face of the driver captured by the camera of FIG. 1.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Virtual Visor System

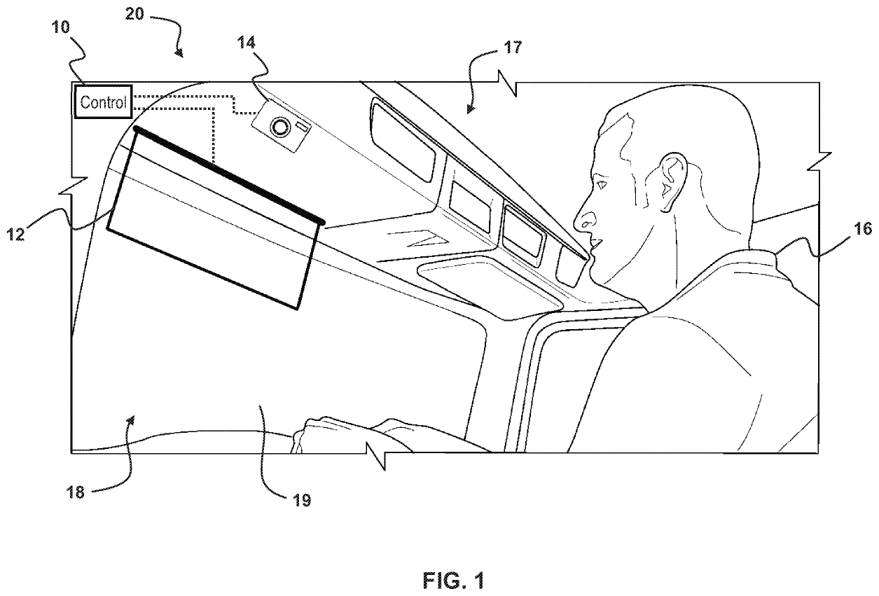

With reference to FIG. 1, an exemplary embodiment of a vehicle mounted virtual visor system 20 is described. Particularly, FIG. 1 shows a partial view of a cabin 17 and windshield 19 of a vehicle 18 in which the virtual visor system 20 is installed. The vehicle 18 may be a passenger vehicle, a commercial vehicle, an off-road vehicle, a recreational vehicle, an airplane, a boat, or any other suitable vehicle. The virtual visor system 20 at least includes a controller 10, a visor 12, and a camera 14. The visor 12 comprises a plurality of independently operable regions, referred to herein as “pixels,” that can be selectively operated with a variable opacity/transparency. The camera 14 captures images of the face of a driver 16 or other passenger and, based on the captured images, the controller 10 operates the visor 12 to automatically and selectively darken a limited portion thereof to block the sun or other illumination source from striking the eyes of the driver 16, while leaving the remainder of the visor 12 transparent. Thus, the virtual visor system 20 advantageously eliminates unnecessary obstructions to the drivers view while also blocking distracting light sources, thereby improving the safety of the vehicle by minimizing disruption of the view of the driver.

In at least some embodiments, the visor 12 is mounted or otherwise attached to a surface within the cabin 17 of the vehicle 18, in the field of view of the driver 16 or other passenger. Particularly, in some embodiments, the visor 12 is mounted to the vehicle 18 so as to be in the line of sight of the driver 16 sitting in the driver's seat and looking through the windshield 19. For example, in the case of a left-hand drive vehicle, the visor 12 may be mounted to the roof adjacent to the windshield 19 so as to cover and/or obstruct at least a portion of an upper-left (as viewed from within the cabin 17) region of the windshield 19. Conversely, in the case of a right-hand drive vehicle, the visor 12 may be mounted to the roof adjacent to the windshield 19 so as to cover and/or obstruct at least a portion of an upper-right (as viewed from within the cabin 17) region of the windshield 19. The visor 12 may be proportioned, mounted, and arranged to cover and/or obstruct any region or regions of the windshield 19, as well as regions of other windows of the vehicle 18. As further examples, the visor 12 may be mounted to any of the pillars of the vehicle 18 adjacent to the windshield 19 or other window, mounted to the dash, or mounted directly to the windshield 19 other window itself in order to cover different regions of the windshield 19 or other windows of the vehicle 18. In some embodiments, the visor 12 may by hingedly or pivotally mounted to an interior surface of the vehicle 18 such that its orientation can be manually adjusted. Alternatively, in some embodiments, the visor 12 is integrated with the glass of the windshield 19 or other window of the vehicle.

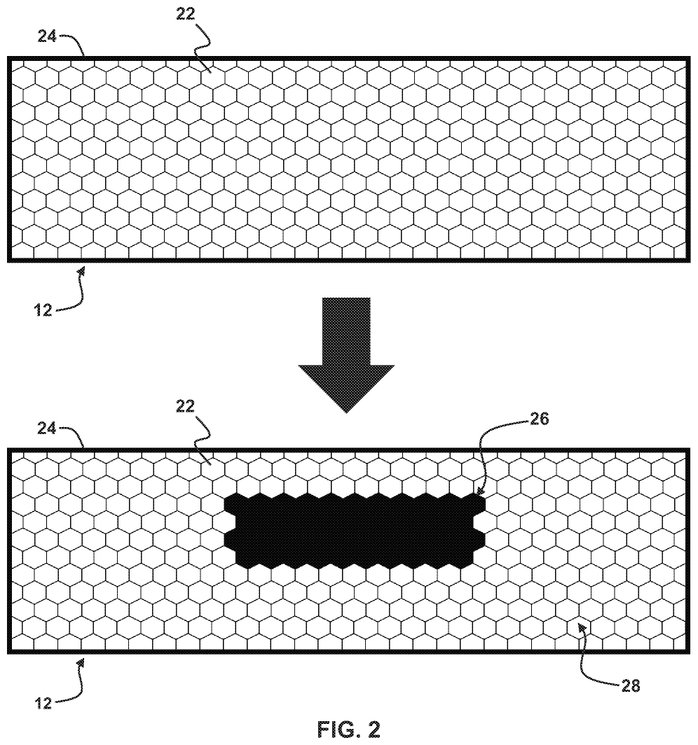

With reference to FIG. 2, the visor 12 comprises a plurality of independently operable pixels 22 that are contiguously arranged to form a panel. As used herein, the term “pixel” refers to any independently operable portion of a medium that is controllable to adjust an optical transparency thereof. In at least some embodiments, the plurality of pixels 22 are contiguously arranged within a bezel 24. In the illustrated embodiment, the pixels 22 each have a hexagonal shape and are arranged in a uniform grid formation. However it should be appreciated that the pixels 22 be of any size and shape and the visor 12 may include non-uniform arrangements of pixels 22 having mixed sizes and shapes. In at least one embodiment, the visor 12 is an LCD panel having LCD pixels 22. However, it should be appreciated that the visor 12 may instead utilize various other technologies in which portions of the visor 12 are electrically, magnetically, or mechanically controllable to adjust an optical transparency thereof.

In order to block sunlight from striking the eyes of the driver 16, a subset of pixels 26 are operated in an opaque optical state, whereas the remaining pixels 28 are operated in a transparent optical state. Particularly, each pixel 22 is configured to be selectively operated by the controller 10 in one of at least two optical states: (1) a transparent optical state in which the respective pixel allows light to pass through a respective area of the visor 12 and (2) an opaque optical state in which the respective pixel blocks light from passing through the respective area of the visor 12. It will be appreciated, however, that any number of intermediate optical states may also be possible. Furthermore, the opaque optical state and the transparent optical state do not necessarily indicate a 100% opaque characteristic and a 100% transparent characteristic, respectively. Instead, the opaque optical state is simply an optical state in which the pixel which blocks more light from passing through the respective area than the pixel does in the transparent optical state.

Returning to FIG. 1, the camera 14 continuously and/or periodically captures images of the face of the driver 16 or other passenger in the cabin 17 of the vehicle 18. The camera 14 is mounted in the vehicle 18 at a location which has a clear view of at least part of the face of the driver 16 so as to detect a shadow cast on the face of the driver 16. In the illustrated embodiment, the camera 14 is mounted or otherwise integrated with the roof of the vehicle 18, above the windshield 19 and directly in front of the driver 16. In another embodiment, the camera 14 is mounted to or otherwise integrated with the dash or steering wheel directly in front of the driver 16. In yet another embodiment, the camera 14 integrated with visor 12, such as in the bezel 24. In a further embodiment, the camera 14 is mounted to or otherwise integrated with the left or right “A” pillar of the vehicle 18.

The controller 10 is configured to receive the images of the face of the driver 16 from the camera 14 and, based on the images, continuously update the optical state of the visor 12. Particularly, based on the images, the controller 10 determines and continuously updates a sunlight direction and a position of the eyes of the driver 16 or other passenger within the cabin 17. Based on the sunlight direction and the position of the eyes of the driver 16 or other passenger, the controller 10 updates the subset of pixels 26 that are operated in the opaque optical state so that the sunlight continues to be blocked from striking the eyes of the driver 16 or other passenger.

The controller 10 generally comprises at least one processor and at least one associated memory having program instructions stored thereon, which are executed by the at least one processor to achieve the described functionalities. It will be recognized by those of ordinary skill in the art that a “controller” or “processor” includes any hardware system, hardware mechanism or hardware component that processes data, signals, or other information. The controller 10 may include a system with a central processing unit, multiple processing units, or dedicated circuitry for achieving specific functionality.

In at least one embodiment, the controller 10 is operably connected to one or more row/column driver circuits (not shown), via which the controller 10 controls the optical state of each individual pixel of the visor 12. The row/column driver circuits may comprise any suitable arrangement of multiplexers, transistors, amplifiers, capacitors, etc. configured to control the optical state of each individual pixel of the visor 12 in response to control signals provided by the controller 10. In some embodiments, portions of the row/column driver circuits may be integrated with the visor 12 and the pixels thereof. In some embodiments, portions of the row/column driver circuits may be integrated with the controller 10.

### Method of Operating the Virtual Visor System

A variety of methods and processes are described below for operating the virtual visor system 20. In these descriptions, statements that a method, processor, and/or system is performing some task or function refers to a controller or processor (e.g., the processor of the controller 10) executing program instructions stored in non-transitory computer readable storage media (e.g., the memory of the controller 10) operatively connected to the controller or processor to manipulate data or to operate one or more components in the virtual visor system 20 to perform the task or function. Additionally, the steps of the methods may be performed in any feasible chronological order, regardless of the order shown in the figures or the order in which the steps are described.

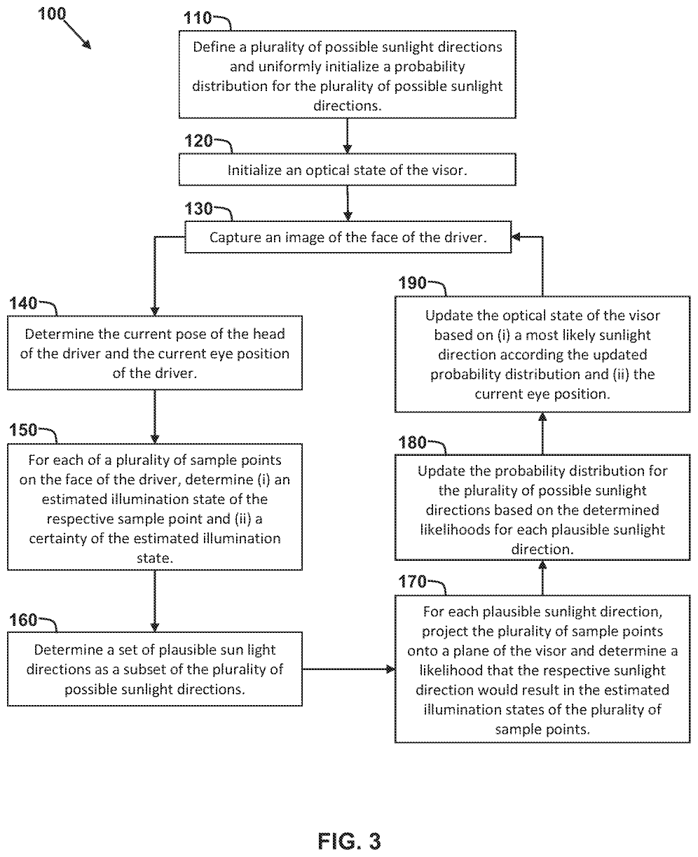

FIG. 3 shows a method 100 for controlling an optical state of the visor 12 to continuously block sunlight from striking the eyes of the driver 16 or other passenger. The method 100 advantageously uses Bayesian Inference to estimate the sunlight direction and a human pose estimation algorithm to estimate the position of the eyes of the driver 16 or other passenger within the cabin 17. Based on these two parameters, the method 100 controls the optical state of the visor 12 to automatically and continuously block sunlight from striking the eyes of the driver 16. In this way, the method 100 continuously prevents sunlight from striking the eyes of the driver 16, without the need for manual adjustment and while minimizing disruption to the rest of the view of driver 16 through the windshield 19.

Although described primarily with respect to blocking sunlight from striking the eyes of the driver 16, it should be appreciated that the method 100 is equally applicable to blocking sunlight from striking the eyes of other passengers in the vehicle 18. Additionally, although described primarily with respect to sunlight, it should be appreciated that the method 100 is equally applicable to blocking light from any other light source, including multiple light sources (e.g., oncoming vehicle headlights).

The method 100 begins with a step of defining a plurality of possible sunlight directions and uniformly initializing a probability distribution for the plurality of possible sunlight directions (block 110). Particularly, due to its large size and distance from the earth, the sun essentially acts as a directional light source. Thus, the sunlight direction can be represented by vector that passes through the visor 12 and toward the driver 16. Though, it should be appreciated that some non-parallel sunrays may pass through the visor 12 and, as such, this vector is merely an approximation. This vector can be represented by a pair of angles including the angle at which the sunlight passes through along a first axis (e.g. a horizontal axis) and the angle at which the sunlight passes through along a second axis (e.g., a vertical axis). For example, the sunlight direction can be represented by the angle pair [θ_{X}, θ_{Y}], where −90°<θ_{X}<90° is a horizontal angle at which the sunlight passes through the visor 12 and −90°<θ_{Y}<90° is a vertical angle at which the sunlight passes through the visor 12. In this example, a sunlight direction [0°, 0°] is normal to the plane/surface of the visor 12. Alternatively, in another example, the ranges for the angle pair [θ_{X}, θ_{Y}] can be defined relative to the viewing direction of the camera 14, such that a sunlight direction [0°, 0°] is normal to the viewing direction of the camera 14 and the possible ranges for the angle pair [θ_{X}, θ_{Y}] depend on the relative angle of the visor 12 compared to the viewing direction of the camera 14.

However, it can be assumed that the eyes of the driver 16 will generally be located within a predetermined region the cabin 17. Thus, only sunlight directions that also pass through this predetermined region within the cabin 17 need to be considered for operating the visor 12 because only this limited subset of sunlight directions will typically result in sunlight striking the eyes of the driver 16. For example, the predetermined region within the cabin 17 might be defined such that only sunlight angles [θ_{X}, θ_{Y}] where −20°<θ_{X}<20° and −10°<θ_{Y}<10° can reasonably be expected to strike the eyes of the driver 16.

The controller 10 defines a plurality of n possible sunlight directions, which can be thought of as a two-dimensional grid of possible sunlight directions. In one example, the controller 10 defines the n possible sunlight directions in 2° increments across the both the horizontal X-direction and the vertical Y-direction and bounded by predetermined region within the cabin 17 within which the eyes of the driver 16 are expected to be located, resulting in, for example, a 20×10 grid of possible sunlight directions or n=200 possible sunlight directions. Each of the n possible sunlight directions is initialized with a uniform probability 1/n, such that each of the n possible sunlight directions is assumed to be equally likely at the start of the method 100. The resulting probability distribution can be considered to take the same form as the grid of possible sunlight directions (e.g., a 20×10 grid of probabilities) and collectively add up to 1.0 or 100%. The controller 10 stores the n possible sunlight directions and the associated probabilities in a memory of the controller 10. As will be described in further detail, these probabilities will be continuously updated and refined based on new information, for example using Bayes' Theorem, to arrive at an accurate prediction of the current sunlight direction.

The method 100 continues with a step of initializing an optical state of the visor (block 120). Particularly, the controller 10 initializes the visor 12 by operating the visor 12 to have a predetermined initial optical state. As used herein, the “optical state” of the visor 12 refers to collective optical states (i.e., opaque, transparent, or any optical state therebetween) of all of the pixels 22 of the visor 12. In at least some embodiments, the predetermined initial optical state includes at least some pixels 22 in the opaque optical state such that the initial optical state will cast a shadow on the face of the driver 16. The predetermined initial optical state may include a subset of pixels 22 operated in the opaque optical state that form a cross, a grid, or some other pattern that is optimal for an initial shadow detection on the face of the driver 16. In some embodiments, the controller 10 initializes the visor 12 in response to receiving a control signal from a vehicle computer (not shown) or a driver-operated switch/button indicating that the virtual visor system 20 is to begin operation.

The method 100 continues with a step of capturing an image of the face of the driver (block 130). Particularly, the camera 14, which is oriented toward the face of the driver 16, captures an image of the face of the driver 16. The controller 10 receives the captured image(s) from the camera 14. In at least some embodiments, the camera 14 is configured to continuously or periodically capture images of the face of the driver 16 in the form of video and the processes of the method 100 following the initialization processes of blocks 110 and 120 are repeated for each image frame captured by the camera 14.

The method 100 continues with a step of determining the current pose of the head of the driver and the current eye position of the driver (block 140). Particularly, based on the image(s) captured by the camera 14, the controller 10 determines a current pose of the head of the driver 16 (i.e., the position and orientation of the head within the cabin 17). In at least one embodiment, the controller 10 detects the pose of the head of the driver 16 in the frame using a human pose estimation algorithm. It will be appreciated by those of ordinary skill in the art that human pose estimation algorithm is generally an algorithm that determines a set of key points or coordinates within the image frame that correspond to key features of a person. As applied to images of a human face and pose detection thereof, these key points will generally include facial landmarks including, for example, eyes, ears, nose, mouth, forehead, chin, and the like. It will be appreciated by those of ordinary skill in the art that wide variety of human pose estimation algorithms exist and that many different human pose estimation algorithms can be suitable adapted to determining the current pose of the head of the driver 16.

Based on the current pose, the controller 10 determines the current position of the eyes of the driver 16 within the cabin 17. As mentioned above, the position of the eyes of the driver 16 within the cabin 17 are one of the two parameters required to determine the necessary optical state of the visor 12 to block sunlight from striking the eyes of the driver 16. Once the current position of the eyes of the driver 16 within the cabin 17 is determined, the current sunlight direction must be determined.

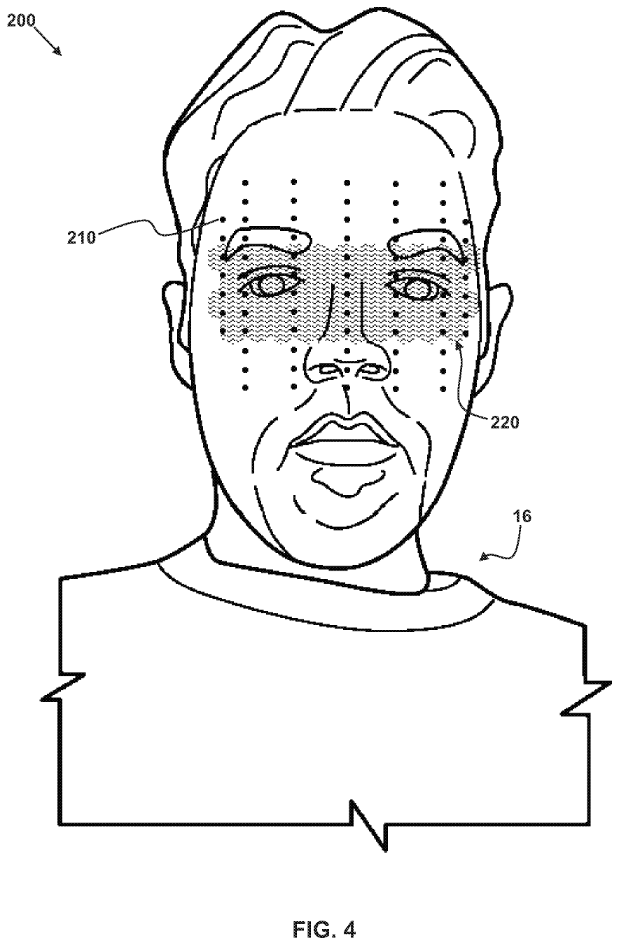

The method 100 continues with a step of, for each of a plurality of sample points on the face of the driver, determining (i) an estimated illumination state of the respective sample point and (ii) a certainty of the estimated illumination state (block 150). Particularly, once the current pose of the head of the driver 16 is determined, a defined set of sample points on the face of the driver 16 is continuously tracked in the image(s) of the face of the driver 16. FIG. 4 shows a portion of an exemplary image 200 of the face of the driver 16. A plurality of sample points 210 are defined on the face of the driver 16 according to a predetermined pattern and distribution and at least include sample points in regions of the face around the eyes of the driver 16. In the illustrated embodiment, the sample points 210 are arranged in seven columns in which the five central columns include an equal number of uniformly spaced sample points 210, and in which the left and right most columns include a smaller number of sample points 210. However, it should be appreciated that a wide variety of patterns can be equivalently utilized. As each image is captured, the controller 10 determines the 2D location in the image of each of the sample points based on the current pose of the head of the driver 16. Particularly, it should be appreciated that the sample points have a defined location on the face of the driver 16 and, thus, when the pose of the head of the driver 16 changes, both the 3D locations of the sample points within the cabin 17 and the 2D locations of the sample points in the images change.

Once the sample points are located in the image, the controller 10 determines an estimated illumination state of each sample point based the image and based on a previously estimated illumination state for each respective sample point. With reference again to FIG. 4, as can be seen, a first subset of the sample points 210 are located within in a shadow 220 that has been projected onto the face of the driver 16 by the optical state of the visor 12 and a second subset of the sample points 210 are located within an illuminated region of the face of the driver 16. In at least one embodiment, the estimated illumination state of each sample point is a binary classification of whether the respective sample point is in a shadow or not in a shadow. However, in other embodiments, the estimated illumination state of each sample point may have more than two possible classifications (e.g., including classifications for intermediate illumination levels). Additionally, in some embodiments, the estimated illumination state of each sample point may be numerical value indicating, in absolute or relative terms, an amount of illumination at the respective sample point in the image.

In at least some embodiments, the controller 10 also determines a certainty of the estimated illumination state of each sample point. Particularly, the shadow detection problem is challenging due to the many variables involved. The face of each driver 16 has a unique skin tone, shape, and size, the shape also varying over time due to different facial expressions of the driver 16. Additionally, the lighting environment that the driver 16 is continually changing, with both direct sunlight as well as indirect light bouncing off the objects and environment around the driver 16. As a result, there is a varying degree of uncertainty in determining whether each sample point on the face is in shadow or not. This uncertainty can lead to a noisy estimation of the illumination states, which can result in unnecessary and distracting changes to the optical state of the visor 12. Therefore, it is advantageous to incorporate the uncertainty into a coherent estimation of the illumination state of each sample point.

The method 100 continues with a step of determining a set of plausible sunlight directions as a subset of the plurality of possible sunlight directions (block 160). Particularly, in at least some embodiments, the controller 10 determines a limited set of plausible sunlight directions as a subset of the plurality of n possible sunlight directions using one or more heuristics designed to eliminate possible sunlight directions that are in fact implausible or impossible. In this way, the method 100 advantageously limits the number of possible sunlight directions that must be tested. However, in at least some cases, the controller 10 does not eliminate any of the n possible sunlight directions and the set of plausible sunlight directions simply includes all of the plurality of n possible sunlight directions.

In some embodiments, the controller 10 determines a first bounding box around all of the pixels on the visor 12 that are operated in the opaque optical state and a second bounding box around all of the sample points on the face of the driver 16 that which are classified to be in a shadow. The controller 10 determines which possible sunlight directions would result in an overlap between the first bounding box around the opaque pixels and the second bounding box around the shaded sample points, after projection of the second bounding box onto the visor. If a possible sunlight direction projects the second bounding box around the shaded sample points onto a region of the visor 12 that does not overlap with the first bounding box around the opaque pixels, then that possible sunlight direction is implausible and does not need to be considered. In addition, all possible sunlight directions that project further the second bounding box from the first bounding box can also be excluded. In other words, a particular sunlight direction does not create an overlap between the bounding boxes, it is easily determined that which possible sunlight directions would result in the bounding boxes being even further from one another.

In some embodiments, the controller 10 determines the limited set of plausible sunlight directions as a subset of the plurality of n possible sunlight directions that are within a predetermined range/difference from the estimated sunlight direction of the previous image frame (e.g., only the possible sunlight directions that are within ±5° in the X or Y directions). The predetermined range/difference will generally be a function of the frame rate at which images are captured by the camera 14 and/or processed by the controller 10. Additionally, the predetermined range/difference may further be a function of a rate of rotation of the vehicle 18 during a turning maneuver.

In some embodiments, the controller 10 determines an expected change in the sunlight direction based on previous changes in the estimated sunlight directions over two or more previous image frames. The controller 10 determines the limited set of plausible sunlight directions based on the sunlight direction of the previous image frame and the expected change in the sunlight direction. As an illustrative example, during a turning maneuver of the vehicle 18, the sunlight directions will generally change one way or the other in the horizontal X direction over a sequence of consecutive image frames. Accordingly, if over the course of the previous few frames, the sunlight direction has shifted positively in the horizontal X direction by a threshold amount, it can be assumed that the sunlight direction in the current frame will continue to shift positively in the horizontal X direction or stay the same. Thus, possible sunlight directions representing negative shifts in the horizontal X direction (i.e., the opposite direction of change compared to the previous frames) can be considered implausible.

In some embodiments, the controller 10 is connected to a vehicle computer (not shown) or vehicle sensor (not shown) configured to provide additional contextual information from which changes in the sunlight direction can be inferred, such as a direction of travel, a time of day, acceleration data, steering information, global positioning data, etc. Based on the additional contextual information, the controller 10 eliminates some of the plurality of n possible sunlight directions as being implausible or impossible. In some embodiments, the controller 10 determines an expected change in the sunlight direction based on the additional contextual information and determines the limited set of plausible sunlight directions based on the sunlight direction of the previous image frame and the expected change in the sunlight direction.

The method 100 continues with a step of, for each plausible sunlight direction, projecting the plurality of sample points onto a plane of the visor and determine a likelihood that the respective sunlight direction would result in the estimated illumination states of the plurality of sample points (block 170). Particularly, for each plausible sunlight direction in the limited set of plausible sunlight directions (or, in some cases, each possible sunlight direction in the plurality of n possible sunlight directions), controller 10 projects the sample points on the face of the driver onto a plane/surface of the visor 12 using the respective sunlight direction. As noted above, an estimated illumination state and certainty was determined for each sample point. Thus, the projection of these points onto the plane/surface of the visor 12 results in a set of points in the plane/surface of the visor 12, each point having an estimated illumination state and certainty.

The controller 10 compares the estimated illumination state and certainty of each projected sample point with the optical state of the visor 12 at the time the image was captured. Based on this comparison, the controller 10 determines a likelihood/probability that the current optical state of the visor 12 would have resulted in the estimated illumination states of the sample points. For example, if the sunlight direction used in the projection results in a high correspondence between sample points estimated to be in a shadow and pixels of the visor 12 that are operated in the opaque optical state, then the sunlight direction has a higher likelihood/probability of being correct. Conversely, if the sunlight direction used in the projection results in a low correspondence between sample points estimated to be in a shadow and pixels of the visor 12 that are operated in the opaque optical state, then the sunlight direction has a lower likelihood/probability of being correct.

Once repeated for all of the plausible sunlight directions (or, in some case, all of the n possible sunlight directions), this provides a 2D grid of likelihood/probability estimates in the same form as the grid of possible sunlight directions discussed above (e.g., a 20×10 grid of probabilities). If not done so in their original determination, the controller 10 normalizes the likelihood/probability estimates such that they add up to 1.0 or 100%. Additionally, the controller 10 assigns a zero likelihood/probability estimate to each of the possible sunlight directions that were not tested as a result of being eliminated as being implausible or impossible.

The method 100 continues with a step of updating the probability distribution for the plurality of possible sunlight directions based on the determined likelihoods for each plausible sunlight direction (block 180). Particularly, the controller 10 updates the probability distribution associated with the plurality of n possible sunlight directions, stored in the memory of the controller 10, based on the determined likelihood/probability estimates for the current image. In one embodiment, the controller 10 updates the probability distribution for the plurality of n possible sunlight directions using Bayesian Inference and/or Bayes' Theorem or any other suitable mathematical operation from incorporating new information into a probability estimate. The resulting updated probability distribution takes the same form as the grid of possible sunlight directions discussed above (e.g., a 20×10 grid of probabilities) and adds up to 1.0 or 100%. The controller 10 stores updated probability distribution in a memory of the controller 10. It will be appreciated that the process of estimating the sunlight direction in this manner effectively reduces the effect of the noisy estimation of the illumination states and enables a more stable prediction.

The method 100 continues with a step of updating the optical state of the visor based on (i) a most likely sunlight direction according the updated probability distribution and (ii) the current eye position (block 190). Particularly, the controller 10 determines the current sunlight direction by selecting the sunlight direction having the highest probability value according to the updated probability distribution. Next, the controller 10 projects the current position of the eyes of the driver 16 onto the plane/surface of the visor 12 using the current sunlight direction. Next, the controller 10 determines the updated optical state based on the projected position of the eyes of the driver 16, such that the updated optical state includes an arrangement of pixels operated in the opaque optical state around the projected position of the eyes of the driver 16. Finally, the controller 10 operates the visor 12 to display the updated optical state. In this way, the optical state of the visor 12 reflects to most recent predictions of sunlight direction and the position of the eyes of the driver 16, thereby providing continuous blocking of sunlight from striking the eyes of the driver. After updating the optical state of the visor 12, the method returns to block 130 and begins processing the next image received from the camera 14.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A visor system for a vehicle, the visor system comprising:
a camera mounted within the vehicle and configured to capture a plurality of images of a face of a passenger of the vehicle;
a visor mounted within the vehicle and having a plurality of pixels arranged contiguously, an optical state of the visor being adjustable by selectively operating each respective pixel of the plurality of pixels in one of (i) an opaque optical state in which the respective pixel blocks light from passing through a corresponding area of the visor and (ii) a transparent optical state in which the respective pixel allows light to pass through the corresponding area of the visor; and
a controller operably connected to the camera and to the visor, the controller being configured to receive the plurality of images from the camera and, for each respective image in the plurality of images:
determine, based on the respective image, a current position of the eyes of the passenger;
determine, based on the respective image, a current light direction at which a light source shines through the visor into the eyes of the passenger;
determine an updated optical state for the visor including at least one pixel in the plurality pixels in the opaque optical state to block the light source from shining through the visor into eyes of the passenger, the at least one pixel being selected based on the current position of the eyes of the passenger and the current light direction; and
operate the visor to display the updated optical state.

2. The visor system of claim 1, the controller further configured to, for each respective image in the plurality of images:
determine a pose of a head of the passenger; and
determine the current position of the eyes of the passenger based on the pose of the head of the passenger.

3. The visor system of claim 1, the controller further configured to, for each respective image in the plurality of images:
locate a plurality of sample points on the face of the passenger within the respective image, the plurality of sample points being located at predefined locations on the face of the passenger;
estimate, for each respective sample point in the plurality of sample points, a illumination state of the respective sample point based on the respective image; and
determine the current light direction based on the estimated illumination states of the plurality of sample points.

4. The visor system of claim 3, wherein the respective illumination state of each respective sample point in the plurality of sample points is a binary classification of whether the respective sample point is in a shadow on the face of the passenger.

5. The visor system of claim 3, the controller further configured to, for each respective image in the plurality of images:
estimate, for each respective sample point in the plurality of sample points, a illumination state of the respective sample point based on the respective image and a previously estimated illumination state of the respective sample point for a previously captured image.

6. The visor system of claim 3, the controller further configured to, for each respective image in the plurality of images:
determine, for each respective sample point in the plurality of sample points, a certainty of the estimated illumination state of the respective sample point based on the respective image; and
determine the current light direction based on the certainties of the estimated illumination states of the plurality of sample points.

7. The visor system of claim 3, the controller further configured to, for each respective image in the plurality of images, for each respective light direction in a plurality of light directions:
determine a respective projection of the plurality of sample points onto a surface of the visor using the respective light direction; and
determine a probability that the respective light direction would have resulted in the estimated illumination states of the plurality of sample points based on a comparison of the respective projection of the plurality of sample points onto the surface of the visor with an optical state of the visor at a time the respective image was captured by the camera.

8. The visor system of claim 7, the controller further configured to, for each respective image in the plurality of images:
determine the current light direction based on the probabilities that the plurality of light directions would have resulted in the estimated illumination states of the plurality of sample points.

9. The visor system of claim 7, the controller further configured to, for each respective image in the plurality of images:
update a probability distribution for all possible light directions based on the probabilities that the plurality of light directions would have resulted in the estimated illumination states of the plurality of sample points.

10. The visor system of claim 9, the controller further configured to, for each respective image in the plurality of images:
update the probability distribution for all possible light directions using Bayes' Theorem.

11. The visor system of claim 9, the controller further configured to, for each respective image in the plurality of images:
determine the current light direction based on the updated probability distribution for all possible light directions.

12. The visor system of claim 7, the controller further configured to, for each respective image in the plurality of images:
determine the plurality of light directions as a subset of all possible sunlight directions.

13. The visor system of claim 12, the controller further configured to, for each respective image in the plurality of images:
determine the plurality of light directions based on a previously determined light direction at which the light source shone through the visor into the eyes of the passenger at time before the respective image was captured by the camera.

14. The visor system of claim 1, the controller further configured to, for each respective image in the plurality of images:
determine a projected position of the eyes of the passenger by projecting the current position of the eyes of the passenger onto a surface of the visor using the current light direction;
determine the updated optical state for the visor such that the at least one pixel in the plurality pixels in the opaque optical state is located at the projected position of the eyes of the passenger.

15. The visor system of claim 1, the controller further configured to, before receiving the plurality of images from the camera:
define, and store in a memory, a set of all possible light directions at which the light source can shine through the visor into the eyes of the passenger; and
initialize, and store in the memory, a probability distribution for the defined set of all possible light directions, each possible light direction being uniformly initialized with an equal probability in the probability distribution.

16. The visor system of claim 1, wherein the visor comprises a bezel and the plurality of pixels are arranged within the bezel.

17. The visor system of claim 1, wherein the visor includes a liquid crystal display (LCD) panel and each pixel in the plurality of pixels is an LCD pixel.

18. A method for operating a visor system of a vehicle, the visor system including a visor mounted within the vehicle and having a plurality of pixels arranged contiguously, an optical state of the visor being adjustable by selectively operating each respective pixel of the plurality of pixels in one of (i) an opaque optical state in which the respective pixel blocks light from passing through a corresponding area of the visor and (ii) a transparent optical state in which the respective pixel allows light to pass through the corresponding area of the visor, the method comprising:
capturing, with a camera mounted within the vehicle, a plurality of images of a face of a passenger of the vehicle; and
for each respective image in the plurality of images:
determining, with a controller, based on the respective image, a current position of the eyes of the passenger;
determining, with the controller, based on the respective image, a current light direction at which a light source shines through the visor into the eyes of the passenger;
determining, with the controller, an updated optical state for the visor including at least one pixel in the plurality pixels in the opaque optical state to block the light source from shining through the visor into eyes of the passenger, the at least one pixel being selected based on the current position of the eyes of the passenger and the current light direction; and
displaying, with the visor, the updated optical state.

19. A non-transitory computer-readable medium for operating a visor system of a vehicle, the visor system including a camera mounted within the vehicle and configured to capture a plurality of images of a face of a passenger of the vehicle and a visor mounted within the vehicle and having a plurality of pixels arranged contiguously, an optical state of the visor being adjustable by selectively operating each respective pixel of the plurality of pixels in one of (i) an opaque optical state in which the respective pixel blocks light from passing through a corresponding area of the visor and (ii) a transparent optical state in which the respective pixel allows light to pass through the corresponding area of the visor, the computer-readable medium storing program instructions that, when executed by a processor, cause the processor to:
for each respective image in the plurality of images:
determine, based on the respective image, a current position of the eyes of the passenger;
determine, based on the respective image, a current light direction at which a light source shines through the visor into the eyes of the passenger;
determine an updated optical state for the visor including at least one pixel in the plurality pixels in the opaque optical state to block the light source from shining through the visor into eyes of the passenger, the at least one pixel being selected based on the current position of the eyes of the passenger and the current light direction; and
operate the visor to display the updated optical state.
